(19) United States
(12) Patent Application Publication
(10) Pub. No.: US 2004/0261876 A1
(43) Pub. Date: Dec. 30, 2004

(54) High pressure flexible conduit

(76) Inventors: Anthony G. Warren, Edmonton (CA); Edwin L. Ballard, Katy, TX (US)

Correspondence Address: BENNETT JONES, 4500 Bankers Hall East, 855 - 2nd Street SW, Calgary, AB, T2P 4K7, CA

(21) Appl. No.: 10/612,303

(22) Filed: Jul. 3, 2003

(30) Foreign Application Priority Data
Jun. 27, 2003 (CA) 2,433,914

(51) Int. Cl. F16L 11/00

(52) U.S. Cl. 138/125; 138/98

(57) ABSTRACT

The present invention relates to a high pressure flexible conduit comprising, a conduit extruded from a flexible liner material, and a seamless fibrous sleeve able to withstand high pressure contents braided or woven in a continuous manner fitted around the conduit and not fused or fixably connected to the conduit whereby, the sleeve absorbs the tensile forces in the conduit. A method of braiding or weaving that creates high axial and hoop strength is utilized to create the fibrous sleeve. A protective coating or overweave may be adhered to the outside of the fibrous sleeve. The fibrous sleeve may further be bonded to an end fixture.

### FIELD OF THE INVENTION

The invention relates to a high pressure flexible conduit that can be laid flat and is rollable.

### BACKGROUND OF THE INVENTION

In the field of transporting fluid materials many lay flat flexible hoses have been developed all of which include common elements of construction. Commonly a liner is formed from a material such as poly vinyl chloride (“PVC”), thermoplastic polyurethane (“TPU”) or rubber. Multiple layers of liner materials are sometimes applied to create the core of the hose, depending on the nature of the fluid intended to flow within the conduit. A layer, which in some cases is the outer layer, formed of warp and weft weave may surround the liner and is often bonded to the liner, whether by way of heat or adhesive, or a combination thereof. A further layer of material or coating can encompass the weave layer of the hose to comprise a durable outer surface.

Unfortunately, traditional lay flat hose structure is such that maximum strength is not achieved and the hose is unable to withstand high pressure contents and is likely to burst at pressures upwards of 1200 psig. The woven layer, in particular, is unable to absorb tensile force created when the contents of a hose are under high pressure. The weave applied to the woven layer of a traditional hose is often designed to produce high hoop strength, but does not have high axial strength and is therefore severely limited as regards the amount of pressure that it can withstand.

Alternatively, hose construction aimed specifically at achieving maximum strength or withstanding high pressure contents produce hoses that are not flexible and cannot be easily laid-flat. The result is that it is difficult to transport and store such hoses.

Furthermore, the traditional method of constructing a lay flat hose is to draw a liner through the woven layer. Either the interior of the woven layer or the exterior of the liner is coated with an adhesive. The liner is then inflated and heated to cause the liner to adhere to the woven layer. This method of construction limits the length of the hose achieved due to the fact that the hose produced cannot exceed the length of hose that can be heated.

### SUMMARY OF THE INVENTION

The present invention relates to a high pressure flexible lay flat conduit comprising, a conduit extruded from a flexible liner material and a seamless fibre sleeve able to withstand high pressure contents of up to 25,000 psig, braided or woven in a substantially continuous manner around the liner. The fibre sleeve is overlaid on the liner but free therefrom and in particular is not fused or fixably connected to the liner whereby, the sleeve absorbs the tensile forces in the conduit.

The material from which the conduit liner is extruded may be any flexible material according to the intended contents of the conduit which may include liquid, gas or slurries. The liner may be formed of ultra high molecular weight polyethylene, polypropylene or polyolefin, but is preferably a linear low density polyethylene. Alternate embodiments of the invention could apply virtually any kind of liner material from the traditional rubber or vinyl to ultra high molecular weight polyethylene, polypropylenes, TPU or fluorinated polycarbons such as Kynar™. The material utilized to create the liner will affect the ultimate performance characteristics of the conduit.

The fibre sleeve may be fashioned from any high tensile strength yarn, including Kevlar™, Vectran™ or M5, but preferably is a gel-spun ultra high molecular weight polyethylene. The preferred material creates a hose that is able to withstand high pressure contents of up to 25,000 psig and is also flexible and easy to roll-up, so that the conduit can be stored and transported without difficulty.

The fibre sleeve is woven or braided in a seamless and substantially continuous manner to create a conduit of any length. Any weave or braid technique can be applied to create a seamless sleeve.

In order to protect the conduit, a coating and overweave may be adhered to the fibre sleeve. In the circumstance that the fibre sleeve is created from a material that resists bonding of a coating thereto, a chemical process, according to U.S. Pat. No. 4,880,879, can be applied. Any coating, including PVC, vinyls, or rubber materials may be applied by way of any adhesive agent, if necessary, preferably the coating is dual component MDI or TDI cured polyurea or polyurethane bonded to the fibre sleeve by a polar adhesive. The protective overweave may be created from any fibre including polyester, Vectran™ or nylon, but is preferably created from Kevlar™.

In one embodiment of the invention, an end fixture is attached to the open end of the conduit either for the purpose of releasing the contents of the conduit or to provide an attachment means for connecting the conduit to a corresponding part. Any end fixture may be attached to the fibre sleeve in any manner conducive to the nature of the end fixture. Through the application of the above-mentioned chemical process, the fibre sleeve may be caused to bond with any end fixture by way of an adhesive agent. In this manner, the conduit can be utilized to conduct or expel a wide variety of materials due to the fact that there is no limitation on the end fixture that may be connected thereto.

These and other features and advantages of the high pressure flexible conduit according to the present invention will become more apparent with reference to the following detailed description and drawings.

### BRIEF DESCRIPTION OF THE DRAWINGS

FIG. 1 is a cross-section view showing the liner and woven outer layers of a conduit according to the invention;

FIG. 2 is a fragmentary perspective view taken through the conduit shown in FIG. 1 to illustrate the layers of the conduit;

FIG. 3 is a cross-section view through another conduit showing a liner, a woven layer and a coating adhered to the woven layer;

FIG. 4 is a fragmentary perspective view taken through the hose shown in FIG. 3 to illustrate the layers of the conduit;

FIG. 5 is a cross-section view of an end fixture bonded to the woven layer of a conduit;

### DETAILED DESCRIPTION OF INVENTION

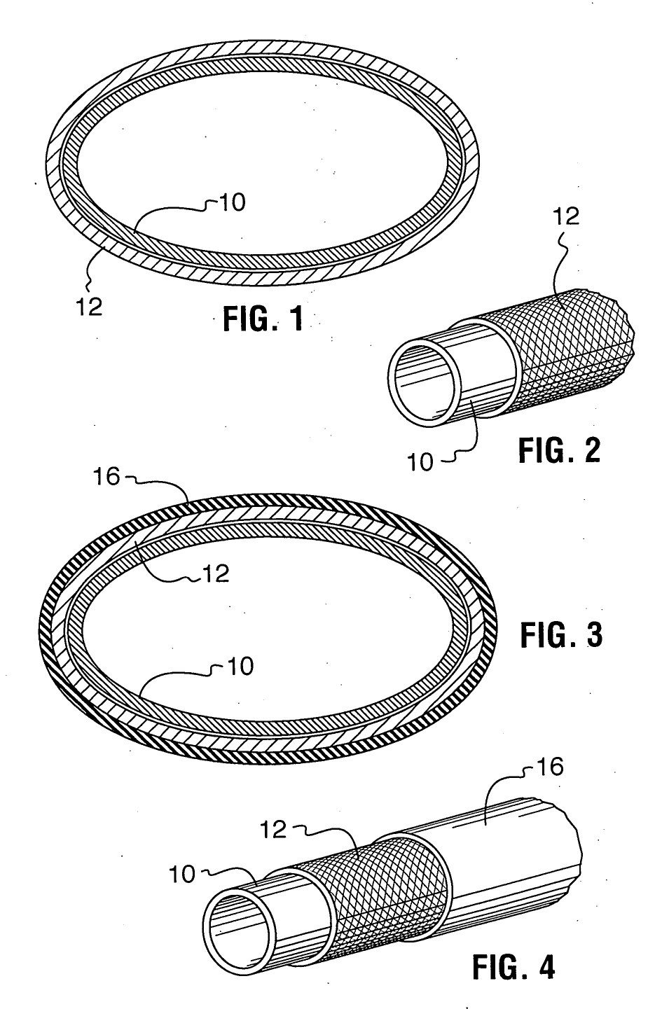

The construction of the flexible high-pressure conduit can be as generally shown in FIG. 1. In one preferred embodiment of the invention, the conduit of the invention comprises a tubular liner 10 extruded from a linear low density polyethylene. The liner is a foldable thickness in the range of 1 mm to 2.5 cm, according to the material utilized to form the liner, and is preferably 40/1000 of an inch. As the material utilized to construct the liner will affect the ultimate performance characteristics of the conduit, such material should be chosen according to the intended contents of the conduit, be they liquid, gas or slurries and the transport conditions of the conduit, such as temperature. Virtually any kind of liner material may be utilized ranging from the traditional rubber or vinyl to ultra high molecular weight polyethylene, polypropylenes, TPU or florinated polycarbons such as Kynar™. The liner may be formed of ultra high molecular weight polyethylene, polypropylene or polyolefin. The preferred embodiment of the invention has a liner created from a linear low density polyethylene.

A fibre sleeve 12 is disposed about liner 10 and is woven around the liner. The liner 10 is preferably not bonded or attached to the sleeve in any manner. As such, the fibre sleeve 12 is separated from the liner and has freedom of movement independent of the liner 10. The resulting conduit is flexible and can be laid flat and rolled without difficulty. However, it is to be understood that over time some adhesion can occur between the parts.

The fibre utilized to create the fibre sleeve is selected to withstand contents under pressures ranging from 500 psig up to 25,000 psig. Any high tensile strength yarn may be used to create the fibre sleeve including Kevlar™, Vectran™, M5, E glass, ECR glass, S-glass, carbons, aramids, nylons, polyesters, liquid crystal polymers and other high strength and/or high stiffness fibres. The preferred embodiment of the invention includes a fibre sleeve 12 that is woven from a gel-spun ultra high molecular weight polyethylene Spectra™ fibre.

As shown in FIG. 2; the fibre sleeve 12 is woven or, preferably braided, around a liner in a substantially continuous manner. The continuity of the braid is interrupted only if the fibre yarn is broken during production at which point a new piece of fibre yarn will be spliced into the braid. The braiding technique thus creates a seamless conduit that is larger in diameter than the liner 10, so as to be able to be fit around the outside surface of the liner and to thereby encompass the liner. In the preferred embodiment the braid is formed around the physical liner member.

A braided fibre sleeve may be created to fit a hose of varying diameters or lengths. In the preferred embodiment of the invention the braid is created so that a balance of both axial strength and hoop strength is achieved. The material utilized and the braiding technique applied optimizes the amount of pressure that the braid will withstand. In the preferred embodiment the braided reinforcement is formed on a 144 carrier maypole braider in a 2×2 regular braid weave using 16 ends of 1300 denier Spectra 2000 per carrier at a braid angle of 54.6 degrees. An equally effective braid could be fabricated using a 1×1 diamond weave, a 3×3 hercules weave, or 1×2, 1×3, 1×4, 1×5, 1×6, 1×7 or 1×8 satin weaves. A variety of braiding machines could be used employing more or fewer carriers and using less or more ends per carrier respectively. Instead of 16 ends of 1300 denier Spectra, fewer ends of higher denier or more ends of lower denier material could be used. In an alternative embodiment the fibre angle can be modified to achieve predictable growth or shrinkage in the deployed and pressurized length of the hose, although the angle of 54.6 degrees is preferred because it minimizes the change in hose length when pressurized.

In the preferred embodiment the chosen construction is biaxial, to facilitate folding and bending the non-pressurized hose. Alternate effective reinforcements can be constructed with triaxial braids. For example, a triaxial braid would be efficient and balanced with a 70-degree braid angle and twice the linear density of yarn in each axial position compared to each bias position. A variety of angles and axial to bias linear density ratios can be utilized.

Referring now to FIGS. 3 and 4, in one embodiment of the invention a protective coating 16 is adhered to fibre sleeve 12. Preferably the coating is polyurea, but essentially any coating material including PVC, vinyl, or rubber materials may be utilized. In the preferred embodiment of the invention a polyurea, being a polar adhesive, is applied to bond the coating 16 to the fibre sleeve 12. In alternate embodiments other adhesives may be applied.

In another embodiment of the invention an overweave may be formed to encompass the fibre sleeve. The overweave provides a protective layer to the conduit and may be created from virtually any fibre including polyester, Vectran™ or nylon. Preferably the overweave is created from Kevlar™. The overweave may be adhered to the fibre sleeve by a polar adhesive such as polyurea. In alternate embodiments other adhesives may be applied.

Inherently an ultra high molecular weight polyethylene has a very low surface energy and therefore it resists bonding to other materials or adhesives. In order to adhere a protective coating or overweave to the fibre sleeve, or attach an end fixture thereto, a process can be applied to the surface of the sleeve 12 whereby the sleeve surface is oxidized to create polar bonding sites thereby increasing the surface energy so that the chemically treated sleeve fibre will bond with an adhesive agent as described in U.S. Pat. No. 6,441,128. In the preferred embodiment this bonding is essential in order to adhere an end fixture to the conduit of the invention.

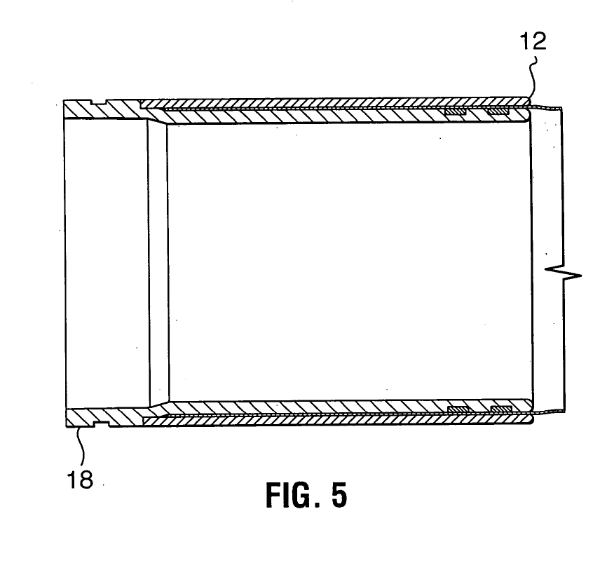

As shown in FIG. 5, in one embodiment of the invention an end fixture 18 is attached to the conduit. Any type of form of end fixture may be attached to the conduit according to the method of attachment applicable to the nature of the chosen end fixture. An end fixture may be attached to the conduit for the purpose of releasing the contents of the conduit, to provide an attachment means for connecting the conduit to a corresponding part, or for any other purpose. In the preferred embodiment of the invention, an end fixture 18 is bonded to the outer surface of a chemically treated fibre sleeve 12 by way of a polar adhesive.

Naturally, the invention is not limited to the embodiments described and variants can be made thereto without going beyond the ambit of the invention as defined by the claims.

In particular, the various numerical values given represent a compromise that is optimal for obtaining a conduit that is flexible, having high strength, including high axial and hoop strength and being able to withstand high pressure. Nevertheless, the various values can be modified to adapt the structure of the hose to special conditions of use.

1. A high pressure flexible conduit comprising:
(a) a conduit liner extruded from a flexible material; and
(b) a seamless fibrous sleeve able to withstand high pressure contents braided or woven in a continuous manner fitted around the conduit whereby, the sleeve has freedom of motion independent from the liner and the sleeve absorbs the tensile forces in the conduit.

2. A high pressure flexible conduit according to claim 1 wherein the conduit is extruded from a linear low density polyethylene material.

3. A high pressure flexible conduit according to claim 1 wherein the sleeve is braided from a gel spun ultra high molecular weight polyethylene whereby high axial and hoop strength are achieved.

4. A high pressure flexible conduit comprising:
(a) a conduit extruded from a flexible material;
(b) a seamless fibrous sleeve able to withstand high pressure contents braided or woven in a continuous manner fitted around the conduit whereby, the sleeve has freedom of motion independent from the liner and the sleeve absorbs the tensile forces in the conduit; and
(c) a protective layer encompassing the outer surface of the sleeve whereby, the sleeve is protected from deterioration due to exterior influences and wear and tear as it absorbs the tensile forces in the conduit.

5. A high pressure flexible conduit according to claim 4 wherein the conduit is extruded from a linear low density polyethylene material.

6. A high pressure flexible conduit according to claim 4 wherein the sleeve is braided from a gel spun ultra high molecular weight polyethylene whereby, optimum axial and hoop strength are achieved.

7. A high pressure flexible conduit according to claim 4 wherein the protective layer is a coating or an overweave.

8. A protective layer according to claim 7 wherein the coating is polyurea.

9. A protective layer according to claim 7 wherein the overweave is formed of aramid.

10. A high pressure flexible conduit according to claim 7 comprising a method of adhering the protective layer to the sleeve surface whereby the protective layer is adhered to the sleeve surface by way of a process that oxidizes the surface of the sleeve to create polar bonding sites and increase the surface energy so that the surface of the sleeve bonds with an adhesive substance that fuses the protective layer to the outer surface of the sleeve.

11. A high pressure flexible conduit comprising:
(a) a conduit extruded from a flexible material;
(b) a seamless fibrous sleeve able to withstand high pressure contents braided or woven in a continuous manner fitted around the conduit whereby, the sleeve has freedom of motion independent from the liner and the sleeve absorbs the tensile forces in the conduit;
(c) a protective layer encompassing the outer surface of the sleeve whereby, the sleeve is protected from deterioration due to exterior influences and wear and tear as it absorbs the tensile forces in the conduit; and
(d) an end fixture engaged to the sleeve.

12. A high pressure flexible conduit according to claim 10 wherein the conduit is extruded from a linear low density polyethylene material.

13. A high pressure flexible conduit according to claim 10 wherein the sleeve is braided from a gel spun ultra high molecular weight polyethylene whereby, optimum axial and hoop strength are achieved.

14. A high pressure flexible conduit according to claim 10 wherein the protective layer is a coating or an overweave.

15. A protective layer according to claim 13 wherein the coating is polyurea.

16. A protective layer according to claim 13 wherein the overweave is formed of Kevlar™.

17. A high pressure flexible conduit according to claim 13 comprising a method of adhering the protective layer to the sleeve surface whereby, the protective layer is adhered to the sleeve surface by way of a process that oxidizes the surface of the sleeve to create polar bonding sites and increase the surface energy so that the surface of the sleeve bonds with an adhesive substance that fuses the protective layer to the outer surface of the sleeve.

18. A high pressure flexible conduit according to claim 10 wherein the end fixture is bonded to the sleeve by way of a process which oxidizes the surface of the sleeve to create polar bonding sites and increases the surface energy so that the sleeve surface can bond with an adhesive substance that fuses the end fixture to the sleeve surface.
